(19) United States
(12) Patent Application Publication
(10) Pub. No.: US 2006/0057411 A1
(43) Pub. Date: Mar. 16, 2006

(54) Masking material

(75) Inventors: Masanori Ogawa, Tokai-shi (JP); Kuninori Ito, Tokai-shi (JP)

Correspondence Address: Donald S. Dowden;Cooper & Dunham, 1185 Avenue of the Americas, New York, NY, 10036, US

(73) Assignee: Nagoya Oilchemical Co., Ltd., Aichi (JP)

(21) Appl. No.: 10/542,921

(22) PCT Filed: Jan. 21, 2004
(86) PCT No.: PCT/JP04/00516

§ 371 Date: Jul. 20, 2005

(30) Foreign Application Priority Data
Jan. 23, 2003 (JP) 2003-14614

(51) Int. Cl. B32B 27/32

(52) U.S. Cl. 428/516; 525/240; 524/502

(57) ABSTRACT

The object of the present invention is to manufacture a masking member having a complex shape and being highly accurate. To attain said object, the present invention provides a masking member made of a modified polypropylene in which 5 to 30% by weight of polyethylene and/or ethylene-propylene copolymer is mixed in with polypropylene. In a case where polyethylene and/or ethylene-propylene copolymer is mixed in with polypropylene, the elongation of said polypropylene improves, also improving its moldability.

### FIELD OF THE INVENTION

The present invention relates to a masking member used to protect a specific part of an article not to be coated when said article is coated.

### BACKGROUND OF THE INVENTION

Prior to coating, a masking member is attached to a specific part (part to be masked) of an article to be coated. Said masking member may be removed from said part after coating, drying and curing, by heating it, to dissipate the fluidity of its coating film. Accordingly, said masking member should have resistance to the heat treatment in the above mentioned coating process. Hitherto, a masking member, made of a thermoplastic resin, in which an inorganic filler is mixed, has been provided as the masking member, having resistance to said heat treatment (see Patent Literature 1, for example).

In said thermoplastic resin, polypropylene has a particularly good resistance to chemicals and solvents, and in a case where an inorganic filler is mixed in with said polypropylene, the mechanical strength of said polypropylene is reinforced and the heat resistance improves since the heat transfer coefficient of the polypropylene in which the inorganic filler is mixed rises, so that said masking member made of polypropylene in which an inorganic filler is mixed can be used repeatedly in the coating process.

Patent Literature; Tokkai Hei 2-126966

Generally, said masking member is manufactured by vacuum and/or pressure forming a polypropylene sheet in which an inorganic filler is mixed. Said polypropylene sheet, however, shows poor elongation, and it is difficult to mold a molded article having a complex shape by vacuum and/or pressure forming. Nevertheless, in a case where said polypropylene sheet is sufficiently heated to be softened so as to make it possible to mold easily a complex shape, said softened polypropylene sheet may be apt to droop under its own weight, making highly accurate molding difficult.

### DISCLOSURE OF THE INVENTION

Accordingly, to solve said problem, the present invention provides a masking member made of a modified polypropylene, in which 5 to 30% by weight of polyethylene and/or ethylene-propylene copolymer, is mixed in with polypropylene. It is desirable that 20 to 50% by weight of an inorganic filler also be mixed in with said modified polypropylene. Further, said masking member is preferably manufactured by vacuum and/or pressure forming said modified polypropylene sheet.

Additionally, it is desirable that a non-modified polypropylene film cover on one or both sides of said modified polypropylene sheet.

(Action)

Since polyethylene and/or ethylene-propylene copolymer is mixed in with said modified polypropylene as the material of the masking member of the present invention, said modified polypropylene sheet is heated at a temperature up to the point at which said modified polypropylene sheet does not droop under its own weight, and can be molded easily into a highly accurate masking member, having a complex shape.

Nevertheless, in a case where the amount of polyethylene and/or ethylene propylene copolymer mixed in is less than 5% by weight, the moldability of said polypropylene is insufficiently improved, masking it difficult to mold a complex shape, and in a case where the amount of polyethylene and/or ethylene-propylene copolymer mixed in is beyond 30% by weight, said modified polypropylene has a poor hardness, meaning that its shape and dimensional stability, and heat resistance may degrade.

By adding an inorganic filler to said modified polypropylene, its mechanical strength improves and heat transfer coefficient rises, improving its heat resistance. Nevertheless, in a case where the amount of an inorganic filler mixed in is less than 20% by weight, an improvement in heat resistance is not remarkable, and in a case where the amount of an inorganic filler mixed in is beyond 50% by weight, said modified polypropylene sheet has poor elongation, resulting in poor moldability, and furthermore poor chemical resistance.

Generally, said modified polypropylene is molded into a sheet, and in this case, said modified polypropylene sheet can easily be molded into a complex shape, and vacuum and/or pressure forming which is(are) suitably applied to mass production can be employed.

In this case, when a non-modified polypropylene film cover one or both sides of said modified polypropylene sheet, even in a case an inorganic filler is mixed in with said modified polypropylene sheet, the surface of said sheet may be smoothed, and its chemical resistance is improved.

### BRIEF DESCRIPTION OF THE DRAWINGS

FIGS. 1 to 4 relate to the first embodiment of the present invention.

FIG. 1 is a perspective view of a masking member, and the pillar to which said masking member is attached.

FIG. 2 is a sectional view along the A-A line in FIG. 4, illustrating the provisional attaching of said masking member to said pillar.

FIG. 3 is a sectional view along the A-A line in FIG. 4, illustrating the final attaching of said masking member to said pillar.

FIG. 4 is a perspective view, illustrating a case where said masking member is attached to said pillar.

FIG. 5 relates to the second embodiment, and is a perspective view of the masking member and pillar to which said masking member is attached.

FIGS. 6 to 8 relate to the third embodiment.

FIG. 6 is a perspective view of a masking member, and the front bumper of the car to which said masking member is attached.

FIG. 7 is a side-sectional view, illustrating a case where said masking member is attached to said bumper.

FIG. 8 is a cross-sectional view, illustrating a case where said masking member is attached to said bumper.

FIGS. 9 to 12 relate to the fourth embodiment of the present invention.

FIG. 9 is a perspective view of a masking member, and the door window frame of the car to which said masking member is attached.

FIG. 10 is a perspective view, illustrating a case where said masking member is attached to said window frame.

FIG. 11 is a sectional view along the A-A line in FIG. 10.

FIG. 12 is a sectional view along the B-B line in FIG. 10.

FIGS. 13 to 17 relate to the fifth embodiment of the present invention.

FIG. 13 is a perspective view of the masking member, and the instrument panel of a car before coating.

FIG. 14 is a sectional view along the A-A line in FIG. 13.

FIG. 15 is a perspective view, illustrating said instrument panel to which said masking member is attached, after coating.

FIG. 16 is a sectional view along the B-B line in FIG. 15.

FIG. 17 is a perspective view of said instrument panel coated in two colors.

FIG. 18 is a perspective view of the masking member of the seventh embodiment.

FIG. 19 is a perspective view of the masking member of the eighth embodiment.

### DESCRIPTION OF NOTATIONS

11,21,31,41,51,61,71 masking member

### DETAILED DESCRIPTION AND PREFERRED EMBODIMENT OF THE INVENTION

The present invention is precisely described below.

The material used for said masking member of the present invention is a modified polypropylene (hereafter to be described as modified PP) in which polypropylene (hereafter to be described as PP) is modified by polyethylene (hereafter to be described as PE) and/or ethylene-propylene copolymer (hereafter to be described as EPR). As said PE, any kinds of PE such as a high density PE having a density higher than 0.941, an intermediate density PE having a density of between 0.926 and 0.940, a low density PE having a density of between 0.910 and 0.925, and ultra low density PE having a density lower than 0.909, can be used in the present invention, and a preferable PE is low density PE, having good compatibility with said PP and substantially improving elongation.

As said EPR, both rubbery copolymer of ethylene and propylene (hereafter to be described as EPM) and ethylene-propylene-diene terpolymer (hereafter to be described as EPDM), wherein ethylene, propylene, and a dien component, such as dicyclopentadiene, ethylidene norbornene, 1,4-hexadiene, or the like are terpolymerized, can be used.

Five to 30% by weight of PE and/or EPR is(are) mixed in with said PP. In a case where PE and/or EPR is(are) mixed in with said PP in an amount of below 5% by weight, the elongation of said PP is insufficiently improved, and good moldability can not be guaranteed. Further, in a case where PE and/or EPR is(are) mixed in with said PP in an amount of beyond 30% by weight, the resulting modified PP has a poor hardness, poor shape and dimensional stability, and poor heat resistance.

In said modified PP, one or more kind(s) of inorganic filler may be added, said inorganic filler being such as calcium carbonate, magnesium carbonate, barium sulphate, calcium sulphate, calcium sulfite, calcium phosphate, calcium hydroxide, aluminum hydroxide, magnesium hydroxide, magnesium oxide, titanium oxide, iron oxide, zinc oxide, alumina, silica, diaton earth, dolomite, gypsum, talc, clay, asbestos, mica, calcium silicate, bentonite, white carbon, carbon black, iron powder, aluminum powder, glass powder, stone powder, blast furnace slag, fly ash, cement, zirconia powder or the like. Generally, said inorganic filler may be added to said modified PP in an amount of between 20 and 50% by weight. In a case where said inorganic filler is added in an amount of below 20% by weight, the improvements in mechanical strength and heat resistance are less evident, and in a case where said inorganic filler is added in an amount of beyond 50% by weight, the moldability and chemical resistance of said modified PP sheet may degrade.

Further, one or more kind(s) of organic filler, such as linter, linen, sisal, wood flour, coconut flour, walnut flour, starch, wheat flour or the like, natural fiber such as cotton, hemp, bamboo fiber, coconut fiber, wool, asbestos, kenaf, or the like; synthetic fiber such as polyamide fiber, polyester fiber, polyolefin fiber, acrylic fiber, vinyl chloride fiber, vinylidene choloride fiber or the like; semi synthetic fiber such as viscose fiber, acetate fiber, or the like, inorganic fiber such as asbestos fiber, glass fiber, carbon fiber, ceramic fiber, metallic fiber, whisker, or the like may be added to said modified PP, to improve its shape and dimensional stability, and compression and tensile strength. Generally said filler(s) is(are) added to said modified PP in an amount of between about 0.05 and 200% by weight.

If necessary, one or more kind(s) of thermoplastic resin(s), such as a vinyl chloride group resin, acrylic resin, methacrylic resin, vinylidene chloride group resin, vinyl propionate group resin, polyester group resin, or the like may be mixed in with said modified PP.

Said modified PP may be colored by a pigment or dyestuff to distinguish its masking parts, and additionally, a plasticizer such as a DOP, DBP, or the like, an antioxidant, antistatic agent, crystallization agent, flame retardant, antiflaming agent, insecticide, antiseptic, various waxes, a lubricant, age resister, ultraviolet absorber, and a blowing agent of a chemical or capsule type, or the like may be mixed in with said polymer alloy. Two or more kinds of said agents may be mixed, and then added to said modified PP.

To manufacture said masking member using said modified PP, a method wherein said modified PP is molded by vacuum and/or pressure forming to be a molded film or sheet, having a prescribed shape, is the most suitable method for molding a deep drawing shape or complex shape, and for mass production, but, aside from said method, pressure forming, press molding, the blow forming, and injection molding also may be applied in the present invention.

A film or expanded film of thermoplastic resin, such as polyolefin such as PE, non-modified PP, EPR, ethylene-vinyl acetate copolymer, or the like, polyvinyl chloride group resin, acrylic resin, methacrylic resin, poly-vinylidene chloride group resin, styren group resin, vinyl propionate group resin, styrene-butadiene copolymer, polyester group resin, or the like, may be laminated onto said modified PP sheet on one side or both sides.

In view of interlaminar adhesion and heat resistance properties, a non-modified PP film is preferable. When a filler, particularly an inorganic filler, is added to, and mixed with modified PP, said film secures the sheet surface's smoothness, improving its chemical resistance. Usually a modified PP sheet's thickness is 300 to 600 μm, and when a film is formed on the surface of a sheet, the thickness of said film is 10˜100 μm.

In order to enhance the affinity of the polymer alloy masking member surface with paint or adhesive, a surface treatment such as a corona discharge treatment, primer coating treatment, or the like, may be performed.

The primer used for the primer coating treatment is, for example, a synthetic resin type primer, such as modified polyolefin, or an olefin copolymer (e.g. chlorinated polypropylene, ethylene-vinylacetate copolymer), a synthetic rubber, such as styrene-butadiene rubber, acrylonitrile-butadiene rubber, chloroprene-rubber, polybutadien, or the like; an acrylic synthetic resin, vinyl synthetic resin, an acrylic synthetic resin containing an amino group and/or amide group, a vinyl synthetic resin containing an amino group and/or amide group, an amino synthetic resin, epoxy resin or the like; and a low-molecular weight compound primer, such as aluminum alcholate or an aluminum chelate agent, such as aluminum isopropylate, aluminum triacetylacetonate, or the like; an alkyl metal, such as 2-ethylhexyl lead, hexadecyl lithium or the like; an organotin compound, such as dibutyl tin diacetate, di-n-butyl tin dioxide, or the like; a silane compound, such as methylvinyl dichloro silane, or the like; a metal complex salt of a 1, 3-dicarbonyl compound, such as acetylacetone lithium, acetylacetone beryllium, or the like; an organotitanium compound, such as tetrabutyl titanate, or the like; a boric acid compound, such as tri-n-butyl borate, triphenyl borate, or the like; a phosphate, such as trioleil phosphate, tridecyl phosphate, or the like; a metal salt of carboxylic acid, such as magnesium stearate, cobalt naphtenic acid, or the like; a metal thioalcholate, such as n-potassium dodecylmercapto chloride, or the like; a thiodicarboxylate, such as zinc 2-ethylhexane dithiocarboxylate, or the like; a metal salt of dithiocarbamic acid, such as nickel dimethyldithiocarbamate, copper dimethyldithiocarbamate or the like; a metal salt of sulfonic acid, such as nickel benzenesulfonate, or the like; an organophosphate compound such as dibutylvanadium phosphate, or the like. One or more kinds of said primer may be used together.

A preferable primer is an acrylic synthetic resin, containing a quarternary ammonium salt, or an amino group synthetic resin.

For the primer coating treatment, a solution or emulsion(latex) of one or more kinds of said primer is coated on the surface of said engineering plastic as the material for the masking member, and then dried.

Prior to said primer coating treatment, an affinity treatment may be exercised on the surface of said engineering plastic. Examples of said affinity treatment include flame treatment, sulfuric acid treatment, corona discharge treatment, or the like, with the surface of said engineering plastic being slightly carbonized by said treatment, to gain affinity with the other synthetic resin.

### Embodiments

### The First Embodiment

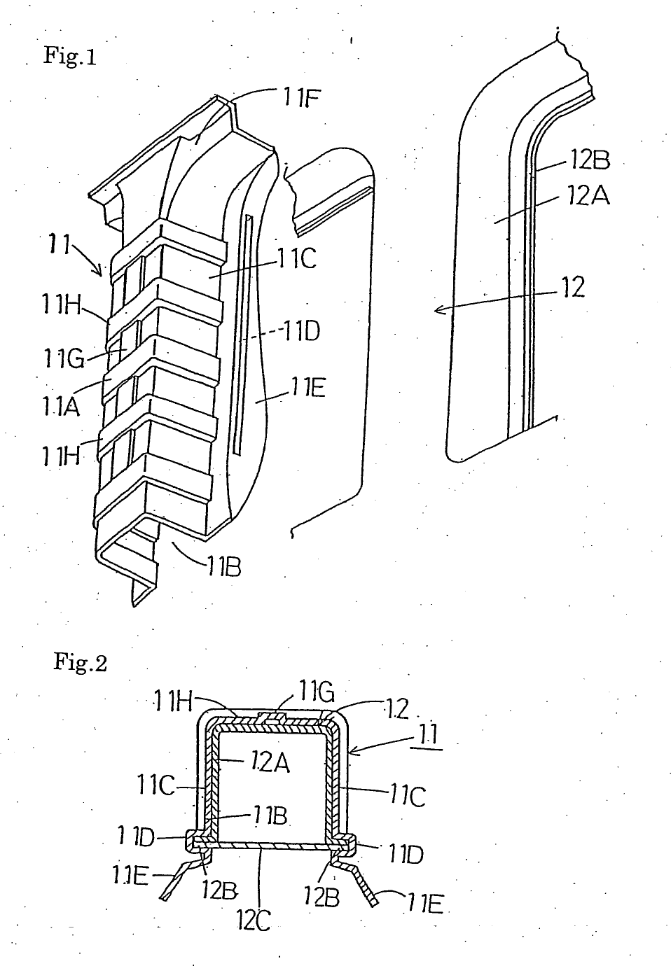

FIGS. 1 to 4 relate to the first embodiment of the present invention. The masking member (11) of this embodiment is used to protect pillar shaped members, such as the center pillar (12) of a car from being coated. Said masking member (11) consists of a body (11A) having a U-shape in cross section, to the inside (11B) of which the body (12A) of the center pillar (12) is to be fitted, a pair of flange grooves (11D, 11D) formed along the lower edges of the side walls (11C, 11C) of said body (11A) into which the pair of flanges (12B, 12B) from said center pillar (12) are each to be inserted, a pair of back side application parts (11E, 11E) each extending from said flange grooves (11D, 11D), and an upper side application part (11F) extending from the top of said body (11A), with a reinforcing longitudinal rib (11G) and reinforcing horizontal ribs (1H) being formed around the circumference of said body (11A).

Said masking member (11) is manufactured by vacuum forming a modified PP sheet (the thickness 340 μm), wherein 18% by weight of low density PE is mixed in with PP, with 30% by weight of talc being mixed with said modified PP.

As shown in FIG. 2, said masking member (11) is provisionally attached to the body (12A) of said center pillar (12) by fitting said body (12A) to the inside (11B) of said body (11A) of said masking member (11), and then further inserting each flange (12B, 12B) of said center pillar (12) into the flange grooves (11D, 11D) of said masking member (11).

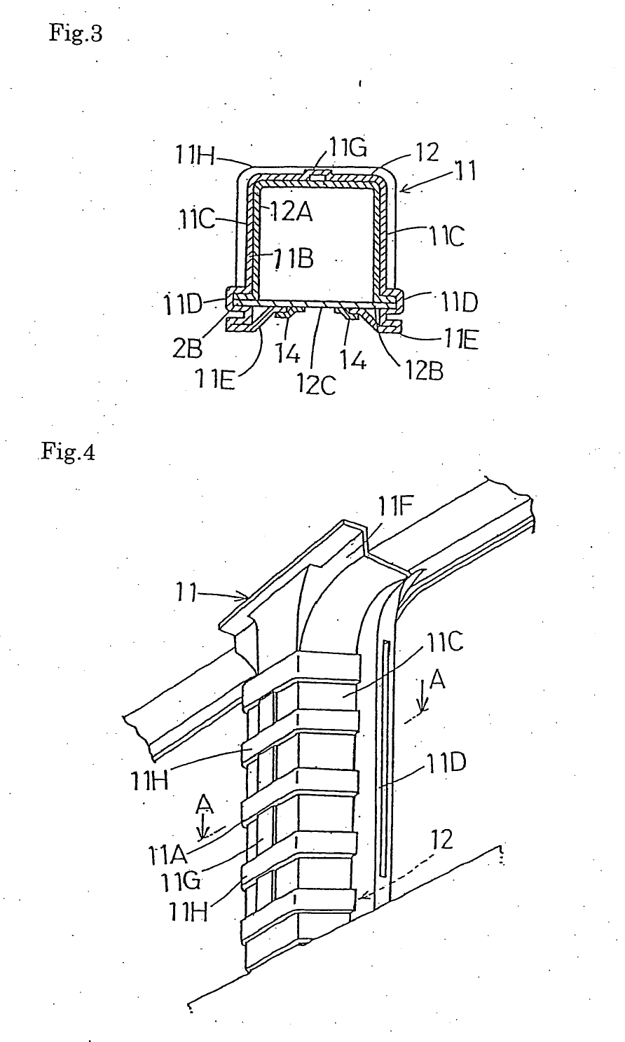

After said provisional attachment, said back side application parts (11E, 11E) are each applied to the back side panel (12C) of said center pillar (12), turning said back side application parts (11E, 11E) to the rear, and said back side application parts (11E, 11E) being fixed to said back side panel (12C) with adhesive tape (14), tacks, or the like, as shown in FIG. 3.

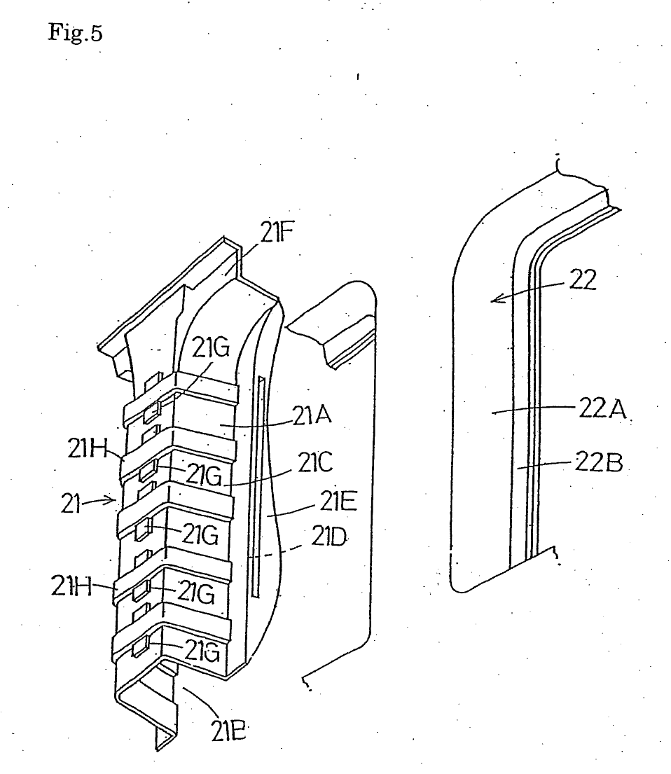

After said masking member (11) is attached to said center pillar (12), as shown in FIG. 4, the car is coated with a thermosetting melanine-alkyd resin paint or the like.

### The Second Embodiment

FIG. 5 relates to the second embodiment of the present invention. The masking member (21) of this embodiment consists of a body (21A) having a U-shape in cross section, to the inside (21B) of which the body (22A) of a center pillar (22) is to be fitted, a pair of flange grooves (21D, 21D) formed along the lower edges of the side walls (21C, 21C) of said body (21A), into which a pair of flanges (22B, 22B) from said center pillar (22) are each to be inserted, a pair of back side application parts (21E, 21E) extending from said flange grooves (21D, 21D), and an upper side application part (21F) extending from the top of said body (21A), with a plural number of reinforcing longitudinal ribs (21G) and reinforcing horizontal ribs (21H) being formed around the circumference of said body (21A).

Being different from the first embodiment, said reinforcing longitudinal ribs (21G) are formed intermittently in this embodiment.

Said masking member (21) is manufactured by vacuum-pressure forming a laminated sheet wherein a non-modified PP film (thickness 30 μm) is laminated onto both sides of a compound sheet (thickness 320 μm), said compound being made of a modified PP, in which 15% by weight of EPDM is mixed in with PP, with 35% by weight of calcium carbonate and 3% by weight of carbon black being mixed in with said modified PP.

In the same way as stated in the first embodiment, said masking member (21) is provisionally attached to the body (22A) of said center pillar (22) by fitting said body (22A) to the inside of said body (21A) of said masking member (21), and then further inserting each of said flanges (22B, 22B) from said center pillar (22) into the flange grooves (21D, 21D) of said masking member (21), following which the back side application parts (21E, 21E) are both applied to the back side panel of said center pillar (22), turning said back side application parts (21E, 21E) to the rear, said back side application parts (21E, 21E) being fixed to said back side panel (22), with adhesive tape, tacks, or the like.

After said masking member (21) is attached to said center pillar (22), the car is coated with paint.

In the first embodiment, said masking member (11) is apt to bend horizontally along said reinforcing longitudinal rib (11G), since said rib (11G) is continuous, while in this embodiment, said masking member (21) has increased horizontal bending strength along its ribs (21G), since said ribs (21G) are intermittent.

### The Third Embodiment

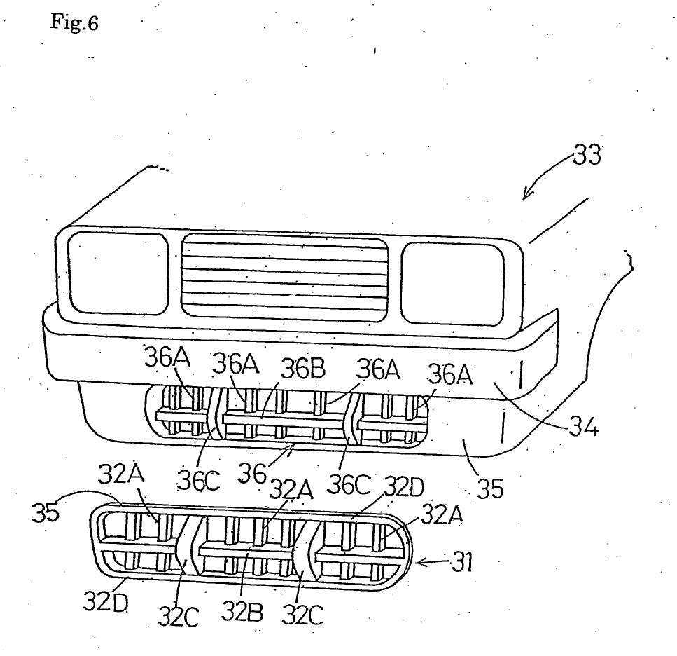

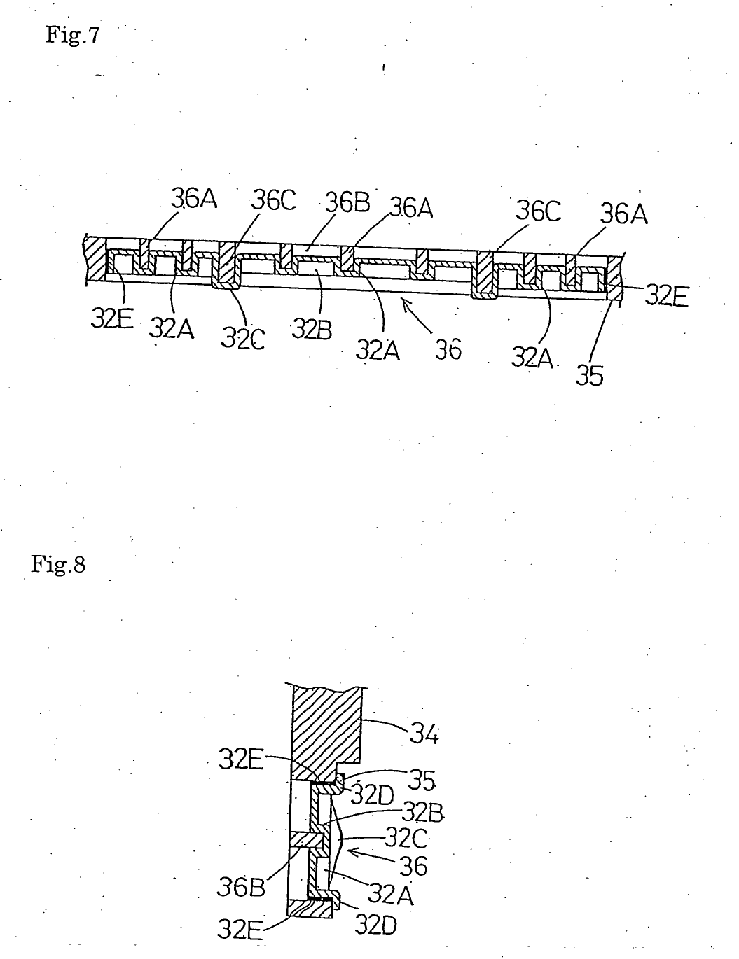

FIGS. 6 to 8 relate to the third embodiment of the present invention. As shown in FIG. 6, a car body (33) has a front bumper (34) and when said car body (33) is coated, the masking member (31) of this embodiment is attached to the air inlet hole (36) of the lower skirt part (35) of said front bumper (34). A plural number of reinforcing frame bars (36A, 36B) are equipped lengthwise and breadthwise, with a pair of support pillars (36C) being equipped on either side of said air inlet hole (36). Correspondingly, the frame bar grooves (32A, 32B), for the insertion of said reinforcing frame bars (36A, 36B), are equipped lengthwise and breadthwise in said masking member (31), with a pair of pillar grooves (32C) for the insertion of said support pillars (36C) being equipped on either side of said masking member (31). A flange (32D) is formed along the front of said masking member (31), further, a pressure sensitive adhesive layer (32E) is formed around the circumference of said masking member (31).

Said fitting grooves (32A,32B,32C), for the insertion of said reinforcing frame bars (36A, 36B), and a pain of support pillars (36C), work as ribs to support said masking member (31). At the cross point of the horizontal (longitudinal) fitting groove (32B), and the vertical (short side direction) fitting groove (32A), said horizontal fitting groove (32B) overlaps said vertical fitting groove (32A), for the purpose of improving the horizontal rigidity of said masking member (31), while at the cross point of said vertical fitting groove (32C), and horizontal (short side direction) fitting grove (32B), said vertical fitting groove (32C) overlaps said horizontal fitting groove (32B), to improve the rigidity of said masking member (31) in its vertical direction.

Said masking member (31) is manufactured by vacuum forming a laminated sheet wherein a non-modified PP film (thickness 30 μm) is laminated onto both sides of a compound sheet (thickness 350 μm), said compound being made of made of a modified PP, in which 20% by weight of low density PE is mixed in with PP, with 20% by weight of talc, 5% by weight of calcium carbonate, and a small amount of antistatic agent and antioxidant being mixed in with said modified PP.

Said masking member (31) is fitted to the inside of said air inlet hole (36), with each reinforcing frame bar (36A, 36B) being inserted into each frame bar groove (32A, 32B), and each support pillar (36C) being inserted into each pillar groove (32C), following which said masking member (31) is then fixed to the inside of said air inlet hole (36) by its pressure sensitive adhesive layer (32E). Said pressure sensitive adhesive layer (32E) may not always be necessary in the present invention.

As described above, said masking member (31) is attached to said air inlet hole (36) of the skirt part (35), which is a masking part, after which said car body (33) is coated with paint, following which, the resulting coating film is cured by heating.

### The Fourth Embodiment

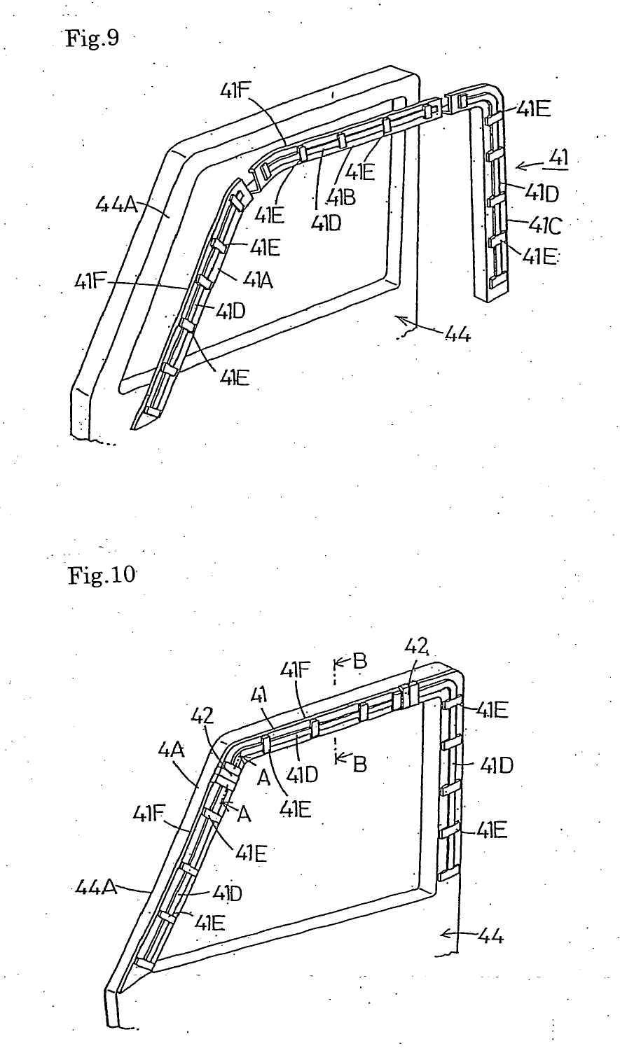

FIGS. 9 to 12 relate to the fourth embodiment of the present invention. The masking member (41) of this embodiment is used to protect the window frame (44A) of a car door (44), and said masking member (41) consists of three parts (41A, 41B, 41C), each part in cross section being L-shaped. A longitudinal reinforcing rib (41D) and cross ribs (41E) are formed in each part (41A, 41B, 41C).

Said masking member (41) is manufactured by vacuum-pressure forming a laminated sheet, wherein a non modified PP film (thickness 50 μm) is laminated onto a compound sheet, (thickness 350 μm), said compound being made of a modified PP, in which 30% by weight of low density PE is mixed in with PP, with 27% by weight of talc being mixed in with said modified PP, and the surface of said masking member (41) receives a corona discharge treatment.

In order to attach said masking member (41) to said window frame (44A) of the door (44), each part (41A, 41B, 41C) is attached to said window frame (44A), overlapping each of the connecting ends of said parts (41A, 41B, 41C), said overlapping connecting ends being fixed with adhesive tape (42), etc. as shown in FIG. 10.

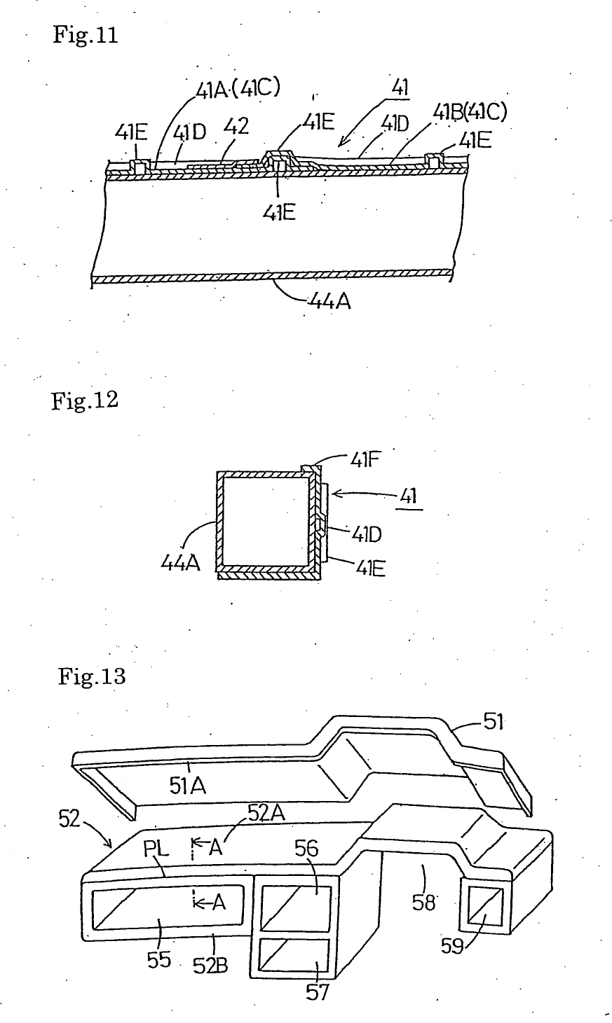

In this case, as for said overlapping connecting ends, a cross rib (41E) from the connecting end of one part (41A or 41B) is fitted under a cross rib (41E) from the connecting end of the other part (41B or 41C) as shown in FIG. 11, with an upper edge hook part (41F) from each part (41A, 41B, 41C) being hung on the upper edge of said window frame (44A) as shown in FIG. 12. After coating, said masking member (41) is removed from said window frame (44A) of the door (44). Said window frame (44A) is not coated with paint since said window frame (44A) was protected by said masking member (41).

Since the surface of said masking member (41) has received a corona discharge treatment, the layered paint formed on the surface of said masking member (41) adhere firmly to the surface of said masking member (41), so that the scattering of pieces of dried paint peeling from the surface of said masking member (41) is effectively avoided.

### The Fifth Embodiment

FIGS. 13 to 17 relate to the fifth embodiment of the present invention. In the front of the instrument panel (52) an installation port (55) into which a globe component is installed, installation ports (56, 57) into which an audio system is installed, an installation port (58) into which instruments are installed, and an installation port (59) into which a small articles box is installed, or the likes are provided, said instrument panel being divided into an upper section (52A) and a lower section (52B).

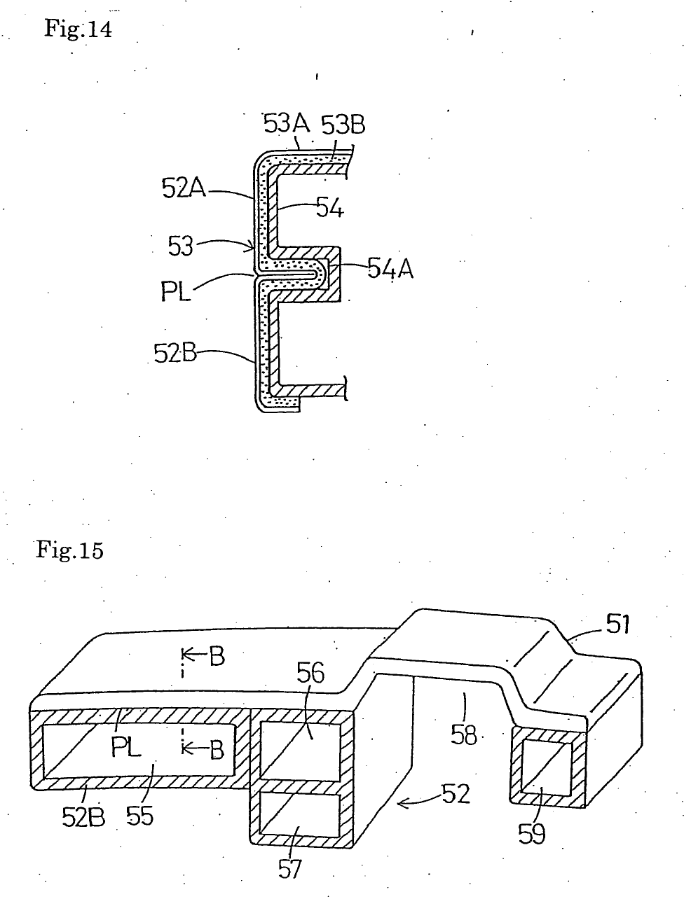

As shown in FIG. 14, said instrument panel (52) consists of a base (54) and a surface trim (53) which is applied to the surface of said base (54), and said surface trim (53) consists of a surface layer (53A) made of a non-woven fabric, synthetic leather, or the like, and a wadding layer (53B) made of a non-woven fabric, foamed plastic sheet or the like, backed with said surface layer (53A), and further said surface layer (53A) is colored with a designated color (base color), and the thickness of said wadding layer (53B) can be elastically compressible.

Along the boundary between said upper section (52A) and said lower section (52B), a groove (54A) is formed in said base (54), with a parting line PL being formed by the insertion of said surface trim (53) into said groove (54A). Said surface trim (53) is fixed to said grooves (54A) with the thickness of said wadding layer (53B) having been compressed, then rebounding elastically. Since said instrument panel (52) is decorated with said surface trim (53) common to both the upper and lower sections, both upper section (52A) and said lower section (52B) are the same color. Said instrument panel (52) may be installed into the car body as it is, or in a case where said instrument panel's (52) upper and lower sections (52A,52B) are different colors, a masking member (51) is used as shown in FIG. 13. Said masking member (51) has a shape corresponding to that of said instrument panel's upper section (52), with an engaging flange (51A) being formed around the circumference edge of said masking member (51).

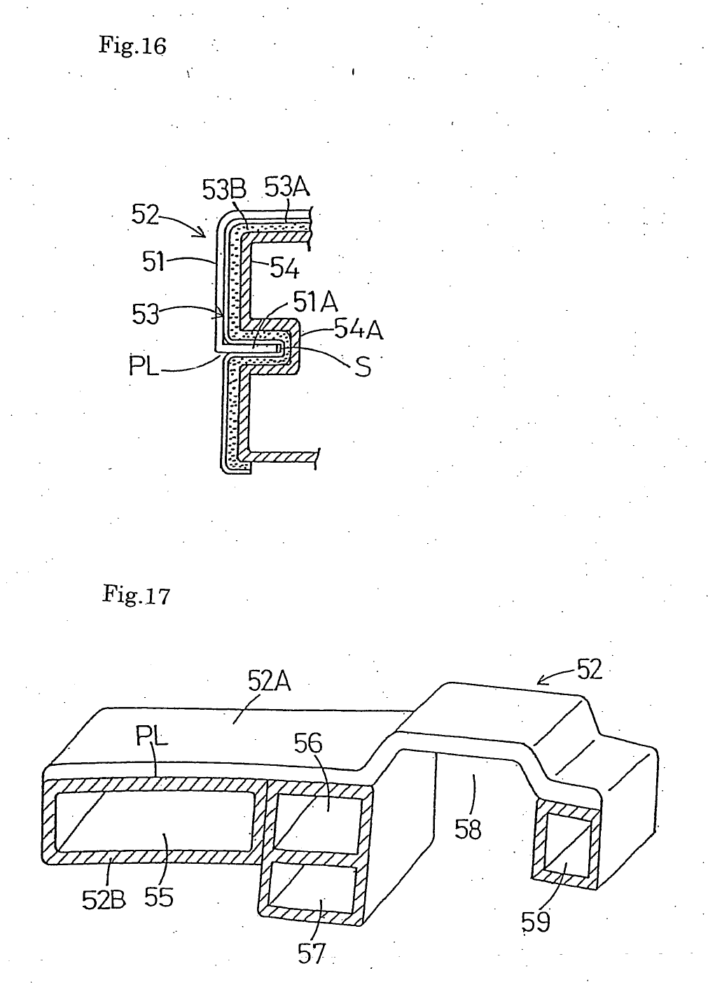

As shown in FIG. 15, said masking member (51) is applied to said instrument panel's upper section (52A), and as shown in FIG. 16, is fixed by the insertion of said engaging flange (51A) into the slit S of said parting line PL. By the insertion of said engaging flange (51A) of said masking member (51) into said slit of said parting line PL, the thickness of said wadding material (51B) of said surface trim (53) is compressed, so that said engaging flange (51A) is pinched and fixed to said surface trim (53), due to said wadding material's rebund and elasticity. As described above, said masking member (51) is applied to said instrument panel's upper section (52A), after which said instrument panel's lower part (52B) is coated in a different color from said upper part (52A) by a method such as spray coating. After coating, said masking member (51) is removed from said upper part (52A).

In the above-described manner, said instrument panel (52), whose upper and lower sections are each coated in different colors, is easily prepared, as shown in FIG. 17.

Said masking member (51) is manufactured by vacuum forming or press molding a laminated sheet wherein a non-modified PP film (thickness 20 μm) is laminated onto the surface of a compound sheet (thickness 350 μm), said compound being made of a modified PP, in which 10% by weight of intermediate density PE and 12% by weight of EPM are mixed in with PP, with 20% by weight of talc and 10% by weight of carbon black being mixed in with said modified PP.

### The Sixth Embodiment

A masking member having the same shape as said masking member of THE FIRST EMBODIMENT is manufactured by the same method as THE FIRST EMBODIMENT by using a compound sheet (thickness 350 μm), said compound made of a modified PP in which 20% by weight of low density PE and 5% by weight of polystyrene are mixed in with PP, with 25% by weight of calcium carbonate being mixed in with said modified PP.

Said masking member of this EMBODIMENT is used to mask the center pillar, the same as said masking member of THE FIRST EMBODIMENT.

### The Seventh Embodiment

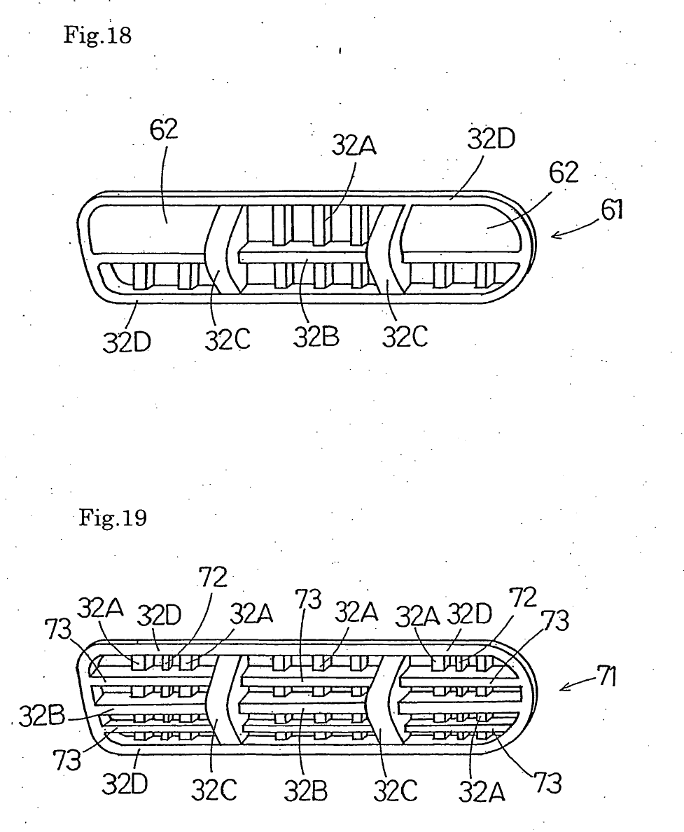

A masking member (61), as shown in FIG. 18 was manufactured, after which it was used for the masking of the air inlet hole (36) of said front bumper (34) of the car in THE THIRD EMBODIMENT.

In said masking member (61), there are fitting grooves (32A, 32B, 32C) into which said reinforcing frame bars (36A, 36B) and said support pillars (36C, 36C) are each to be inserted, with convex parts (62, 62) projecting from the front of said masking member (61), and a flange (32D) being formed around the front of said masking member (61). The lengthwise rigidity of said masking member (61) is improved by the convex shape of said parts (62, 62). By improving its lengthwise rigidity, the swelling at either end of said masking member (61) being caused by warping of said masking member (61) is prevented, said warping being caused by the curing of the paint film applied to said masking member during coating.

Although said reinforcing frame bars (36A, 36B) do not fit into said convex parts (62, 62), said masking member (61) is fixed to said air inlet hole (36) with said fitting grooves (32A, 32B, 32C), without any trouble.

Generally, in a masking member of this type (61), it is not always necessary to set all of said fitting grooves (32A, 32B, 32C) into which all of said reinforcing frame bars (36A, 36B) and, said support pillars (36C, 36C) are to be inserted, as long as the necessary number of fitting grooves (32A, 32B, 32C) to fix said masking member (61) to said air inlet hole (36) are provided. Further, concave parts may be formed instead of said convex parts (62, 62), and are expected to have the same effect.

Said masking member (61) of this EMBODIMENT was manufactured by the same method as described in THE THIRD EMBODIMENT using a laminated sheet wherein a non-modified PP film (thickness 30 μm) is laminated onto both sides of a modified PP sheet (thickness 320 μm), in which 15% by weight of low density PE and 5% by weight of polystyrene-ethylacrylate copolymer is mixed in with PP.

### The Eighth Embodiment

The masking member (71), shown in FIG. 19, for the masking of the air inlet hole (36) of said front bumper (34) of the car in THE THIRD EMBODIMENT was manufactured.

In said masking member (71), there are fitting grooves (23A, 32B, 32C) into which said reinforcing frame bars (36A, 36B), and said support pillars (36C,36C) are fitted, vertical ribs (72, 72), horizontal ribs (73, 73), and a flange (32D) being formed along the front of said masking member (71). Although said fitting grooves (32A, 32B, 32C) work as ribs, the rigidity of said masking member (71) in both its vertical and horizontal directions is further improved by said vertical ribs (72, 72) and horizontal ribs (73, 73).

These ribs give rigidity to the masking member in its lengthwise direction, but degrade its rigidity in its crosswise direction, since the masking member is apt to be folded at said rib. However, at the cross point of ribs, in a case where one rib overlaps another, the rigidity along said overlapping rib can be improved.

As for the masking member (71) of this embodiment, since said horizontal ribs (73,73) are settled to overlap said vertical ribs (72,72), the lengthwise (horizontal) rigidity of said masking member (71) is greatly improved. By improving the lengthwise rigidity of said masking member (71), the swelling at either end of said masking member (71) caused by warping of said masking member (71) is prevented, said warping being caused by the curing of the paint coating film applied to said masking member (71), during coating.

Said masking member (71) of this EMBODIMENT was manufactured by the same method as described in THE THIRD EMBODIMENT, using a laminated sheet, wherein an EPM film (thickness 27 μm) is laminated on to a modified PP sheet (thickness 340 μm), in which 20% by weight of low density PE, and 10% by weight of high density PE are mixed in with PP.

### INDUSTRIAL UTILITY

Said modified PP, used as the material of the masking member of the present invention, has excellent resistance to heat, chemicals and solvents, and excellent moldability, and by using said modified PP, a masking member having deep drawing shape or complex shape is certainly manufactured, said modified PP having especially excellent moldability for vacuum forming, vacuum-pressure forming, and pressure forming, which, are suitable methods for mass-production, the resulting masking member can be molded into any shape corresponding to the shape of the part to be masked.

1. A masking member made of a modified polypropylene sheet in which 5 to 30% by weight of polyethylene and/or ethylene-propylene copolymer is mixed in with polypropylene, said masking member being manufactured by vacuum and/or pressure forming said modified polypropylene into a prescribed shape.

2. A masking member in accordance with claim 1, wherein 20 to 50% by weight of an inorganic filler is mixed in with said modified polypropylene.

3. (canceled)

4. A masking member in accordance with claim 1, wherein a non-modified polypropylene film covers one or both sides of said modified polypropylene sheet.

5. A masking member in accordance with claim 2, wherein a non-modified polypropylene film covers one or both sides of said modified polypropylene sheet.
